(19) United States
(12) Patent Application Publication
(10) Pub. No.: US 2004/0158832 A1
(43) Pub. Date: Aug. 12, 2004

(54) Method and system for scheduling image acquistion events based on dynamic programming

(76) Inventors: Gal Chechik, Moshav Beit-Hanan (IL); Isaac Meilijson, Hod-Hasharon (IL); Tuvik Beker, Givatayim (IL); Yuval Spector, Palo Alto, CA (US); Eytan Ruppin, Reut (IL)

Correspondence Address: GRAY CARY WARE & FREIDENRICH LLP, 2000 UNIVERSITY AVENUE, E. PALO ALTO, CA, 94303-2248, US

(21) Appl. No.: 10/353,761

(22) Filed: Jan. 28, 2003

(51) Int. Cl. G06F 9/00

(52) U.S. Cl. 718/102

(57) ABSTRACT

A method and system for scheduling events into a set of opportunities is presented. The method includes 1) dividing a path of an image acquisition device so that there is at least a first portion and a second portion at any given moment, wherein each of the first portion and the second portion includes at least one state and the first portion includes a null state in which no image is taken; 2) combining each state in the first portion with at least one state in the second portion one by one to generate a series of updated sequences; and 3) selecting at least one of the updated sequences based on a merit value associated with each of the updated sequences. The invention uses only two groups out of all the relevant opportunities for most calculations, and is especially applicable to situations like satellite pass scheduling.

### BACKGROUND

The invention relates generally to event scheduling and particularly to scheduling image acquisition requests for remote sensing satellites fitted with various sensors.

In general, remote sensing satellites travel along predetermined paths in such a way that a particular region of Earth can be observed from one or more of the satellites at several different instants in time. These satellites take images of specific targets (e.g., parts of the Earth or space) in response to image acquisition requests. These image acquisition requests are scheduled along the available satellite paths so that the maximum possible number of the requests can be fulfilled efficiently. This scheduling, which is referred to as Satellite Remote Sensing Scheduling (SRSS), includes determining the activity of a satellite at various times. The satellite may be a single remote sensing satellite or multiple remote sensing satellites.

As is well known, image acquisition tasks can also be achieved by various image acquisition devices other than satellites, for example by aircrafts. To the extent that aircrafts take multiple aerial photos in a single flight, the photo acquisitions need to be scheduled. Thus, for any image acquisition device where a series of images are acquired under physical and temporal constraints, such as with satellites and aircrafts, scheduling the image acquisition tasks dramatically affects the efficiency with which the images are acquired. The determination of the optimum schedule for image acquisition requests presents a challenge.

Scheduling image acquisition tasks for satellites, for example, poses a challenge for a number of reasons. First, even for a few passes of a single satellite, the number of possible scan combinations is enormous. The number of possible scan combinations becomes prohibitively high when multiple satellites are concerned, wherein each satellite is pointing its sensor(s) in a different direction. Second, SRSS cannot be broken down into separate and independent small tasks because the actions are interdependent and each action may affect another action taken at a later point in time. This interdependence may be physical and/or logical. Logical interdependency arises when the user relates two or more imaging requests to one another, as in the case of a request to scan several areas on the same day. Physical interdependency results from maneuvering operations of the satellite required for pointing, energy constraints, recorder overflow, and communication and calibration periods. These dependencies constrain the targets that can or should be scanned, in a way that depend on previously scanned targets, or on future scanning opportunities. When the sensor positions and interdependencies are taken into account, fulfilling all the request parameters (e.g., deadline for taking the image) and working around external constraints become highly challenging.

The large parameter space and the low reducibility make it impractical to perform a complete search over the parameter space. In fact, the SRSS problem in its most general form is known to be NP-Hard, meaning that an efficient solution is unlikely to be found at all. Various approximation attempts for finding a near-optimal solution include use of incomplete optimization algorithms, utilizing heuristics and simplifying assumptions on the original problem. These approaches often lead to inaccurate results. Moreover, much manual effort is required by these current approaches, increasing cycle time and creating bottlenecks in large-scale operations. A method and system for generating at least a near- optimal scheduling solution within a reasonable timeframe is highly desired.

While there are several existing methods that provide partial solutions to the SRSS problem, no current system solves the problem in a satisfactory manner, enabling fully automated high-quality planning for large-scale operations. Existing methods and systems, some of which are described herein, solve the SRSS problem by presenting it in a way that is tractable by generic optimization tool. The method and system in accordance with the invention achieve optimization better than these existing methods by taking into account certain spatial and temporal characteristics which are unique to the SRSS problem and therefore not accounted for in generic optimization algorithms.

### SUMMARY

A method and system for scheduling events into a set of opportunities is presented. The method includes: 1) dividing the image acquisition device path so that there is at least a first portion and a second portion at any given moment, wherein each of the first portion and the second portion includes at least one state and the first portion includes a null state in which no image is taken; 2) combining each state in the first portion with at least one state in the second portion one by one to generate a series of updated sequences; and 3) selecting at least one of the updated sequences based on a merit value associated with each of the updated sequences. The invention overcomes the problem associated with a dauntingly high number of states (opportunities) into which actions can be scheduled by focusing on two subsets out of the entire set of possible states: 1) a state in the timeframe that is being examined and 2) a sequence of states in one or more timeframes that have already been examined. The fact that only two subgroups are considered at a time for most purposes allows fast implementation for solving problems like image acquisition device pass scheduling.

The method and system of the invention borrows from the well-known method of dynamic programming to solve a scheduling-type problem. Dynamic programming, which is a model and/or method for solving multi-step optimization problems, includes examining a number of states. Actions may be scheduled in different orders within a given timeframe, and each state within the timeframe can accommodate only one action at any given time for a single physical entity (e.g., a sensor, a satellite, a disk). In order to determine the sequence of state(s) that would accomplish the user-requested actions in the most efficient manner within the limited timeframe, the invention uses dynamic programming to 1) examine the total timeframe, a slice at a time, wherein each slice contains zero, one, or multiple states, 2) assign each state in the slice a merit value, and 3) maximize the sum of merit values over the total timeframe. In doing so, the invention treats each slice of the total timeframe as a would-be starting point for the remainder of the process.

This scheduling procedure may be used in conjunction with an allocation method. The allocation method first distributes some or all the requested actions to different satellite passes and then schedules the allocated requests within each satellite pass. Appropriate allocation methods include a conflict-based allocation method in which a subgroup (e.g., a requests with the highest priority) of the requests are allocated first and the rest are allocated during the scheduling process.

### BRIEF DESCRIPTION OF THE DRAWINGS

FIG. 1 depicts an overview of a remote sensing operation;

FIG. 2 depicts details of the ground control center of FIG. 1;

FIG. 3 depicts a mission planning system in accordance with the invention;

FIG. 4 depicts details of the mission planning system of FIG. 3;

FIG. 5 depicts a flowchart of the functions of the scheduling subsystem of FIG. 4;

FIG. 6 depicts an allocation method that may be used by the scheduling subsystem of FIG. 4;

FIG. 7 depicts an allocation method that may be used by the mission planning system of FIG. 4 in accordance with the invention;

FIG. 8 schematically depicts a slicing method that may be used by a dynamic programming method in accordance with the invention, which in turn may be used by the mission planning system of FIG. 4 in accordance with the invention;

FIG. 9 depicts a flowchart of the dynamic programming method in accordance with the invention;

FIG. 10 depicts a stripe method that may be implemented to enhance the dynamic programming method of FIG. 9;

FIG. 11A depicts satellite pass plans as may be displayed to a user of the dynamic satellite scheduling system; and

FIG. 11B depicts a satellite plan as may be displayed to a user of the dynamic satellite scheduling system.

### DETAILED DESCRIPTION

The invention is particularly applicable to a system and method for scheduling image acquisition requests in one or more satellite passes, and it is in this context that the invention will be described. It will be appreciated, however, that the system and method in accordance with the invention has greater utility, such as to other types of scheduling needs (e.g., scheduling aerial photographs) and especially to scheduling needs with a high number of possible combinations and permutations that cannot be optimized reasonably well at a practical speed.

“Image acquisition device,” as used herein, is any device that captures an image (visual, infrared, ultraviolet, etc.), such as satellites, ablating telescope, and airplanes that take aerial photos. A “satellite pass,” as used herein, is one passage of a satellite above a specific area on Earth, typically starting when the satellite enters an area of a specific ground station and ending when it leaves this area. More broadly, a satellite pass is a segment of a path of an image acquisition device. A “state,” as used herein, is an opportunity within a satellite pass into which actions or events can be scheduled. In the context of a satellite, for example, each state defines the position of a sensor at the beginning and the end of an opportunity. An exemplary system for a satellite image acquisition device will now be briefly described.

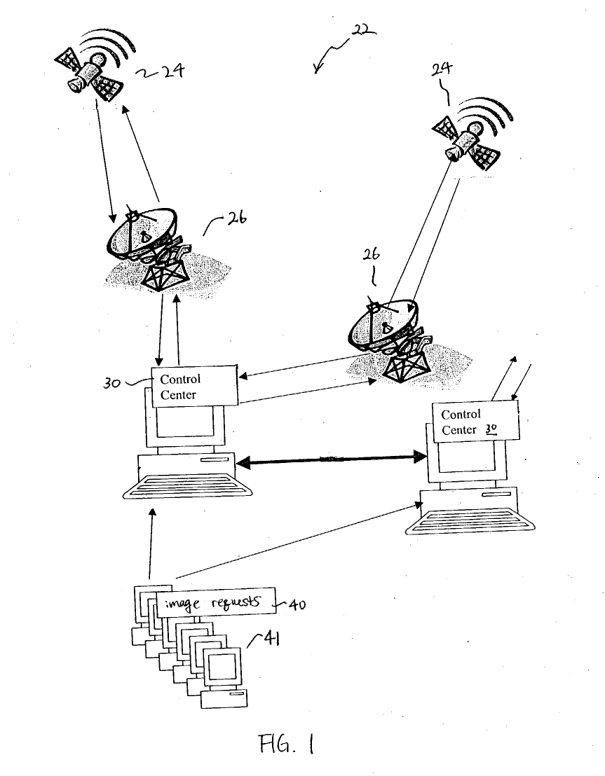

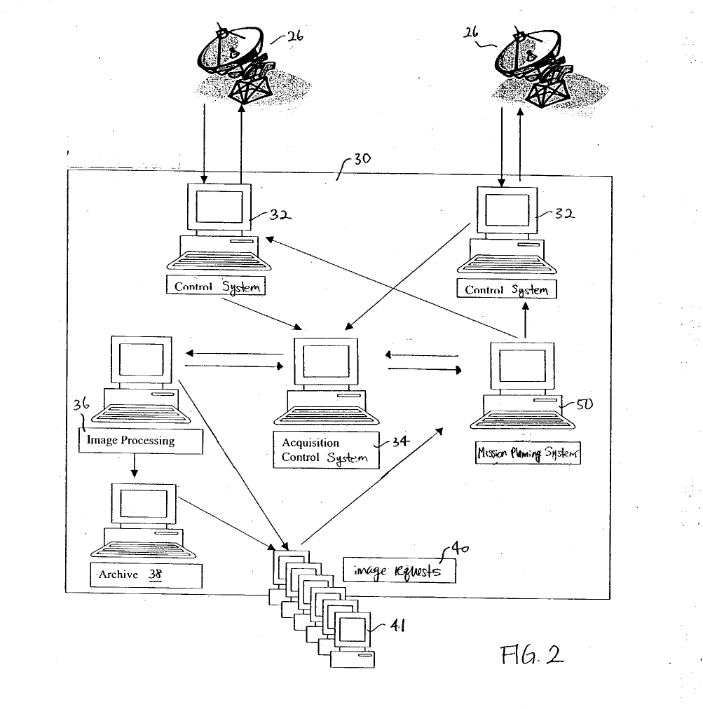

FIG. 1 depicts a remote sensing operation 22. The remote sensing operation 22 includes a plurality of satellites 24 and satellite transceivers 26, a ground control center 30, and a system 41 for receiving and collecting image requests 40. The ground control center 30, the details of which are provided below in FIG. 2, includes a hardware and software infrastructure. The ground control center 30 and the transceivers 26 together constitute what is commonly referred to as a “ground station” for sending and receiving data from a satellite. Usually, the information that is sent to the satellite include commands for satellite maintenance and commands related to mission planning. The information that is received from the satellite include telemetry information for general satellite maintenance, and mission products such as images that have been acquired.

Although FIG. 1 depicts each satellite transceiver 26 communicating with one satellite, 24, a person of ordinary skill in the art would understand that the invention is not so limited, since there may be a plurality of satellites and transceivers wherein each transceiver communicates with more than one satellite. The control center 30 creates instructions for the satellites based on image requests 40, satellite specific models, and external constraints, and forwards them to the transceivers 26. The satellite transceivers 26 receive these instructions (e.g., image acquisition commands) and forward them to the satellites 24. The satellites 24 execute the instructions and send the results back to the transceivers 26, which then forward the results to the control center 30. The control center 30 may include one or more processors (as shown by the two computer systems in FIG. 1) that communicate with one another over a communications link 31, wherein each processor communicates with a certain satellite. The control center 30 processes the results as is appropriate. A person of ordinary skill in the art will understand that the invention is not limited to the exact context provided herein; for example, a plurality of control centers at different locations may communicate with one satellite.

FIG. 2 depicts the control center 30 in more detail. The control center 30 includes a control system 32 that interfaces with the remote sensing operation 22 (of which only the satellite transceivers 26 are shown), an acquisition control system 34, an image processing system 36, and a mission planning system 50. There may be a plurality of control systems 32, wherein each control system interfaces with a particular group of transceivers 26 and communicates with other control system 32 through a network or a direct connection. Each control system 32 communicates with the acquisition control system 34. The acquisition control system 34 also communicates with the image processing system 36 and the mission planning system 50. The image processing system 36 communicates with an archive 38 and can also distribute images directly to customers or through a database on the Internet.

Image requests 40, when received by the control center 30, are processed by the mission planning system 50. The mission planning system 50 allocates the image requests to different satellites and schedules the requests. The schedule is then forwarded to the control system 32, which translates the schedules into satellite commands, and to the acquisition control system 34, which manages the requests and later matches them with results (e.g., obtained images). After the schedule is translated into proper satellite commands, the control system 32 uploads the commands to the satellites 24 (see FIG. 1) via the satellite transceivers 26. The satellites execute the commands and send the results back to the control system 32 via the transceivers 26. The results are then managed by the acquisition control system 34, processed by the image processing system 36, and stored in the archive 38 to be retrieved at a proper time.

In some embodiments, the acquisition control system 34, upon receiving a schedule, may check to see if there is already a matching result in the archive 38. If there is already a matching result, it may cancel the scheduled image request to avoid duplicate effort. The acquisition control system matches up the scheduled requests with the results received from the satellites, keeping the process in order. In some embodiments, the acquisition control system 34 controls the image acquisition process by acting as an intermediary between the mission planning system 50 and the control system 32. In general, the acquisition control system 34 synchronizes all the systems in the control center 30 so that the image acquisition process can be executed smoothly.

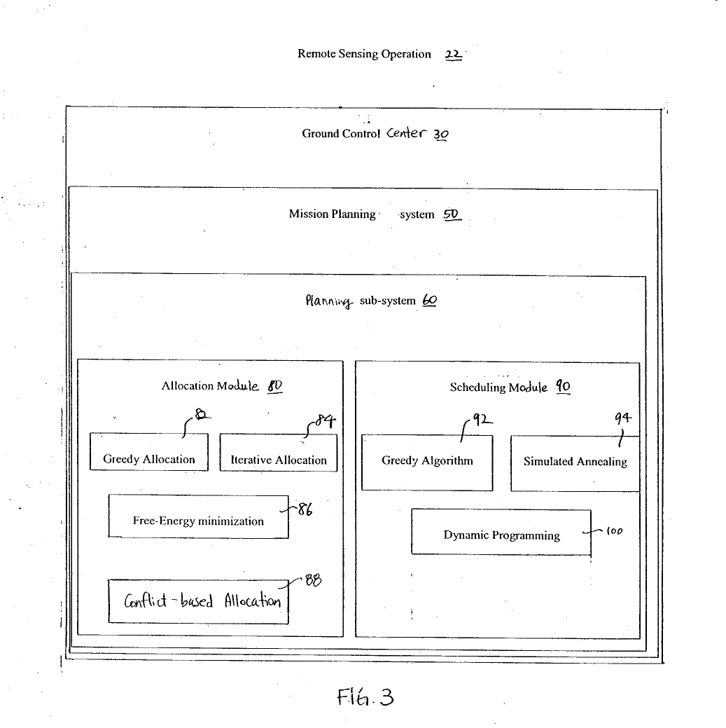

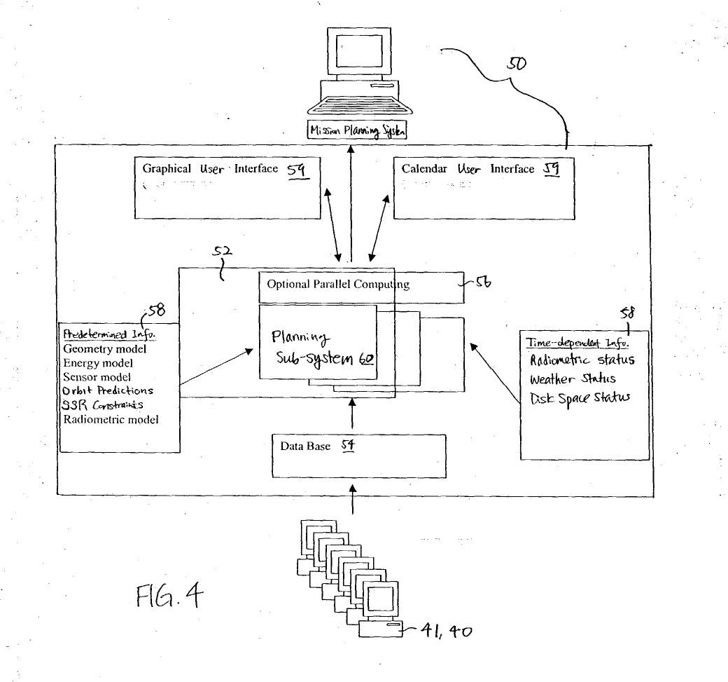

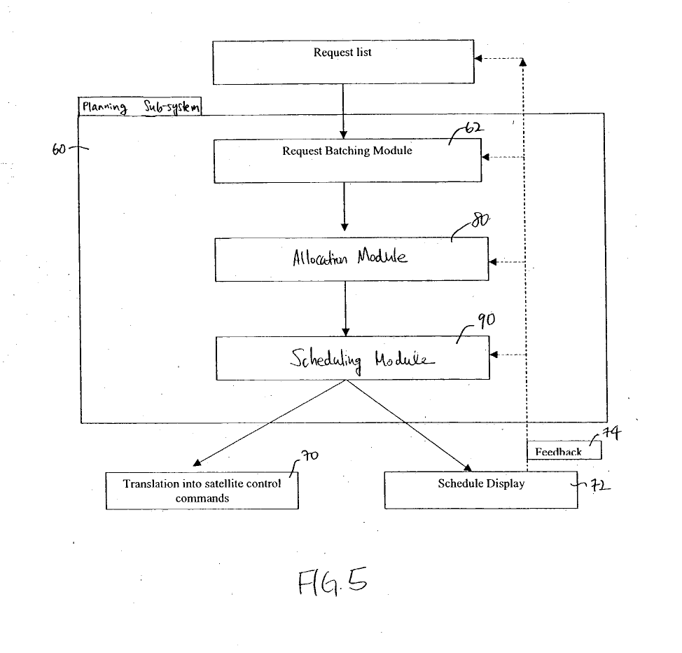

FIG. 3 depicts an overview of the mission planning system 50 in accordance with the invention. The mission planning system 50 includes a planning sub-system 60 that determines how the image acquisition requests should be scheduled for each satellite pass. Details about the mission planning system 50 are provided below in reference to FIG. 4, and details about the planning sub-system 60 are provided below in reference to FIG. 5. In order to achieve this goal of scheduling image acquisition requests, the planning sub- system 60 first allocates at least a part of the requested image acquisitions to different satellite passes based on certain constraints (e.g., their orbits) and then schedules the requests so that they will be carried out in an optimal manner. The allocation may be done by an allocation module 80 using well-known methods such as greedy allocation 82, an iterative allocation method 84, or a free-energy minimization method 86. Alternatively, a conflict-based allocation method 88 may be used in accordance with the invention. The scheduling may be done by a scheduling module 90 based on optimization such as greedy algorithm 92 or simulated annealing 94. Alternatively, the scheduling may be done with a dynamic programming method 100 in accordance with the invention.

FIG. 4 depicts the mission planning system 50 in more detail. The mission planning system 50 may be implemented as one or more computer systems which execute instructions. When image requests 40 are fed into the mission planning system 50, they are first stored in a data base 54. Each of the image requests 40 includes information that the mission planning system 50 uses to schedule the orders in an efficient manner, such as required resolution, required time of day, azimuth, priority, wavelength, scanning mode, and urgency level. A main processor 52 pulls the image requests from the database 54 as needed and plans satellite missions by allocating the image requests 40 to different satellites based on information that may include predetermined information 58a (e.g., satellite information) and time-dependent information 58b (e.g., environmental information). The predetermined information 58a includes but is not limited to information about each satellite's geometry model, energy model, sensor model, orbit predictions, SSR constraints, and radiometric model. As for time-dependent information 58b, it may include information such as weather status, current date and time, radiometric status information such as lighting conditions for the target, disk space status, strength of the signal received by the satellite transceivers 26 (see FIG. 1), direction of the sun, and SSR state information. The information 58a, 58b may also be stored in the database 54 or a separate database, which may be associated with the main processor 52. There may be multiple databases of different types in the ground control center 30, only some of which are included in the mission planning system 50 as database 54. The database 54 also stores all satellite modes (e.g., orbit, sensor properties, energy level).

A planning subsystem 60, which is the core module in the mission planning system 50, uses various parameters in the image requests 40, the predetermined information 58a, and the time-dependent information 58b to schedule the requests so that images can be obtained in an optimized manner. The methods by which the main processor 52 plans satellite missions are described below. Optionally, the planning subsystem 60 includes a parallel computing module 56 that schedules multiple passes simultaneously. “Parallel computing,” as used herein, includes distributing different independent computational tasks between multiple computers or processors.

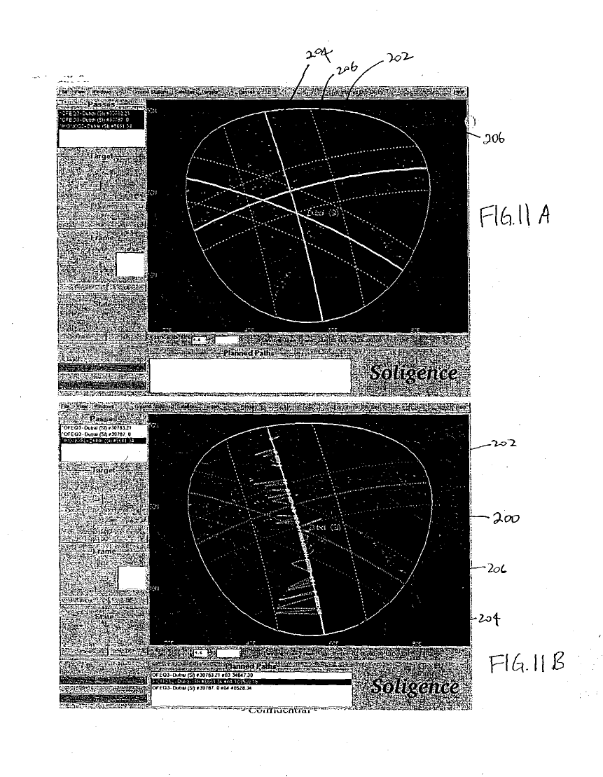

Once the mission planning is completed, the results may be shown in a graphical user interface 59 on a display monitor. A user can view the planned missions through the user interface 59, evaluate the plans, and possibly change some parameters or select the best plan option. Examples of what may be displayed on the user interfaces 59 are shown below, in FIG. 11A and 11B.

FIG. 5 depicts, in a flowchart, some functions of the planning subsystem 60. The planning subsystem 60 first pulls the image request list from the database 54 (see FIG. 4). After reviewing the parameters associated with each image request, a request batching module 62 groups certain requests together. Requests that are “batched” may be requests that can be fulfilled with one image, such as images that are geographically adjacent. The batches usually differ from one another by the positions of the sensors (the devices which acquire the images) and the direction from which the images are taken. Naturally, the batches will include different and possibly overlapping targets. A request may be a part of more than one batch, and the total number of batches usually exceeds the number of requests. For example, where there are three image requests for Area 1, Area 2, and Area 3, batch #1, batch #2, and batch #3 could each include Area 1, Area 2, and Area 3, respectively. In addition, there could be a batch #4 that includes Area 1 and Area 2, a batch #5 including Area 2 and Area 3, a batch #6 including Area 1 and Area 3, and a batch #7 including all three areas, if possible. Topographic features such as shorelines and extreme height differences (favoring certain scanning angles) are taken into account when grouping requests into batches. Multiple combinations of adjacent requests may be generated according to the specification of the various satellites in the constellation. Some batches only contain one request while other batches contain multiple requests.

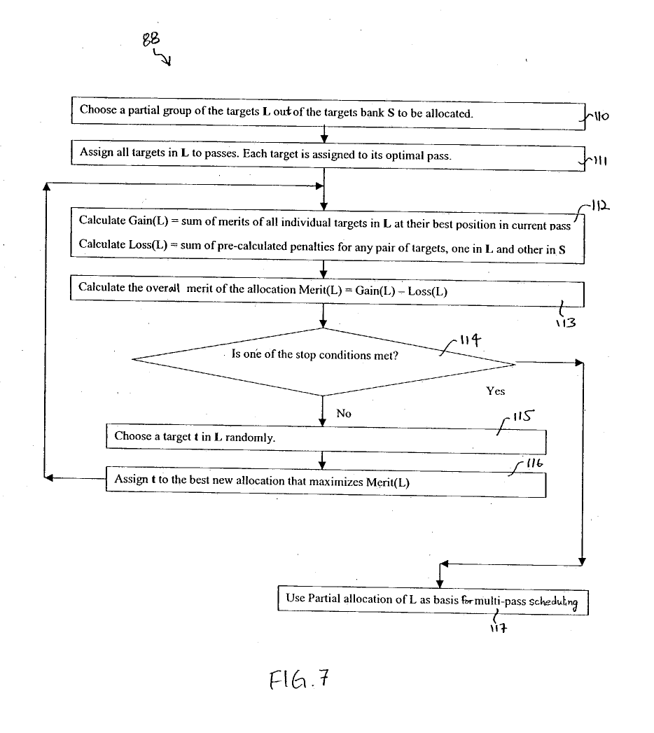

Once the requests are grouped into “batches,” the allocation module 80 allocates each batch to different satellite passes. The allocation may be done in multiple stages, and may be partial or complete. Generally, a request is allocated to a satellite from which the requested image can be obtained at an optimal time and location, taking into account all other request and interdependencies. Well-known allocation methods, such as allocation based on global scoring of pass requests, may be used. Alternatively, allocation may be accomplished using a partial allocation version of the conflicts-based method, described below in reference to FIG. 7. Once requests are allocated to satellite passes, the scheduling module 90 determines the order in which the allocated requests are to be carried out within each satellite pass. The scheduling module 90 may accomplish this scheduling one satellite pass at a time or for multiple satellite passes simultaneously. A translation module 70, which may reside in the control system 32 (see FIG. 2), converts the resultant schedules into satellite commands. The resultant schedules are displayed in the user interface 59 (see FIG. 4). A schedule display module 72 controls what is to be displayed on the user interface 59. A user who receives the schedule through the user interface 59 may then provide feedback 74, for example by editing and refining the schedule. The feedback 74 may add restrictions.

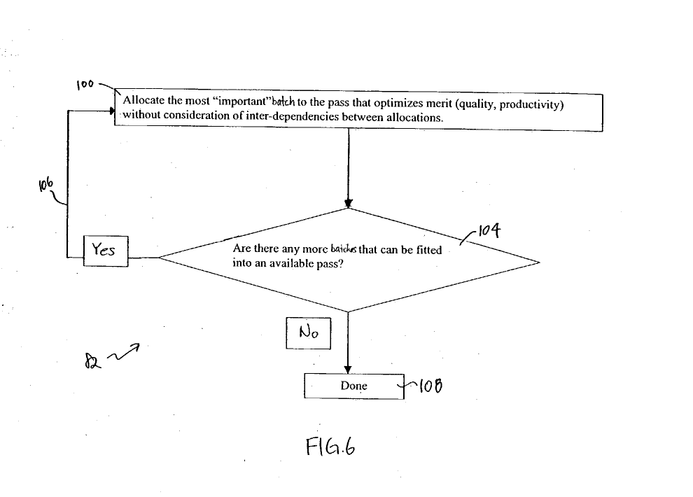

FIG. 6 provides a flowchart of a greedy allocation method 82 that the allocation module 80 may use for mission planning. This greedy allocation method 82 is a well- known method that prioritizes the requests based on their parameters and allocates the requests/batches to the best available slot in the order of their priority without considering how an allocation affects other allocations. Thus, after prioritizing the requests/batches, the greedy allocation module 82 allocates the request/batch associated with the highest priority to a satellite pass that will obtain the best image for this request/batch (stage 100). The satellite pass that will obtain the best image is determined by scoring the available passes based on one or more parameters (e.g., the quality of the image produced) and selecting the pass with the highest score. Then, the greedy allocation module 82 checks the remaining un-allocated batches and the remaining slots on satellite passes and determines if any of the remaining batches can fit into one of the remaining slots on the satellite passes (stage 104). If there are unfulfilled requests that can fit into one or more of the available pass slots, then the unfulfilled requests are allocated based on their priorities when stage 100 is repeated, as indicated by an arrow 106. When there comes a point that no unfulfilled request can be fit into an available pass, the scheduling method is completed (stage 108).

FIG. 7 provides a flowchart of a partial conflicts-based allocation method 88 in accordance with the invention. This partial allocation method takes into account the interdependencies between the scheduled requests without locking into a specific schedule. For simplicity of illustration, a simple version of the conflicts-based allocation method is described here. A person of ordinary skill in the art will understand that many possible extensions can be used with the simple model that is provided.

In this method, the complete set of relevant requests is referred to as “S.” Initially, a partial set of requests L is chosen from the complete set S (stage 110). This partial set L, for example, may be a fixed percentage of the complete set S including the members of set having the maximum merit values. Then, each of the requests in the partial set L is assigned to its optimal pass (stage 111) and the Gain and the Loss for all the allocated requests are calculated (stage 112). The Gain is the sum of merits of all the allocated requests at their best position in a given pass. The Loss, on the other hand, is the sum of penalties associated with each of the allocated requests. The penalties, which are pre- calculated, reflect an estimated decrease in merit caused by the particular allocation. For example, when a spot that is the optimal scheduling spot for multiple requests causes a conflict, assigning one target to the spot is associated with not only an increase in merit due to this optimal scheduling but also a decrease in merit because the other target(s) now cannot be assigned to its (their) optimal spot. All conflicts between pairs of requests such as this are accounted for and the penalty associated with each conflict is stored in a database. The overall Loss of an allocation is a function of all pair-wise conflicts, e.g., the sum of all conflicts.

Once the Loss and the Gain are determined, the overall merit of the allocation is calculated by taking into account both the Loss and the Gain (stage 113). If no stop conditions are met at this point (stage 114), an already-allocated request is chosen in a random manner (stage 115) and re-allocated to improve the overall merit of the allocation (stage 116). A new overall merit is calculated with this reallocation, and the iterative process continues until one of the stop conditions are met in stage 114. Exemplary stop conditions include failure to achieve a minimum improvement in merit over a pre-selected number of iterations and/or passage of a pre-selected length of time. A person of ordinary skill in the art will understand how to define and implement a stop condition tailored to the relevant application. Once one of the stop conditions is met, the final partial allocation is used as a basis for scheduling (stage 117). The scheduling is done on a pass-by-pass basis or on multiple passes using a multiple-pass basis, as described below. During scheduling, the exact spot to which a target is allocated may be changed, depending on the embodiment.

The allocation can also be implemented by using the well-known method of “simulated annealing” (Kirkpatrick, Gelatt, & Vecchi, Optimization by Simulated Annealing, Science, 220(4598):671-680, 1983). Details on allocation of imaging requests by simulated annealing are provided in U.S. Pat. No. 6,405,186 to Fabre et al., which is incorporated herein by reference.

Other well-known methods of allocation may be used. Also, allocation can be accomplished in a flexible manner. For example, after a group of requests is allocated to different passes, the already-made allocations can be adjusted as the remaining requests are scheduled.

Once the requests are allocated to satellite passes, they are scheduled within each satellite pass whereby the order of the allocated requests is determined. The methods used for scheduling may be similar to the methods used for allocation. For example, a “greedy” scheduling method similar to the greedy allocation method 82 may be used. In this “greedy” scheduling method, the requests that are allocated to a single pass of a satellite or multiple passes of a satellite by the allocation module 80 (see FIG. 3) are ranked by importance based on the specifications associated with each request, and the most important request is scheduled into the optimal slot for that request. The second most important request is scheduled into the best slot that is left available after scheduling the most important request, the third most important request is scheduled into the best slot that remains thereafter, and so on. This method may be used instead of the “greedy” scheduling method (described above) to schedule the requests either within a single pass or for multiple passes. Each possible schedule is associated with a merit value that reflects how efficient the schedule is in terms of time, resources, and image quality.

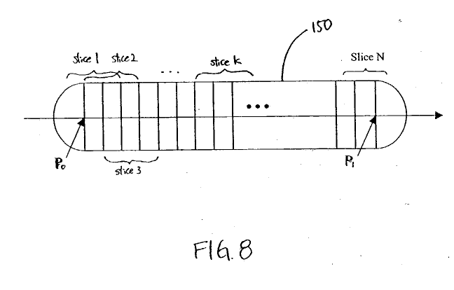

FIG. 8 schematically depicts the idea of “slicing” a given satellite pass that underlies a “dynamic programming” scheduling method in accordance with the invention. A coverage area 150, which in this case has an elongated shape, depicts the geographic area that can be scanned in a single scanning pass. Since a satellite moves in a substantially predetermined path at a substantially constant speed, the coverage area 150 also represents a single pass travel time. Preferably, the coverage area 150 is divided into unequal and overlapping slices dividing the coverage area 150. FIG. 8, however, shows the slices as being equal for clarity of illustration. Observing the coverage area from the point P₀ of entry into the ground station transmission range, this coverage area is divided into N overlapping slices. In the example shown, slice 1 covers the area closest to the entry point (P₀) and slice N includes the area that is closest to the exit point (P₁) at the end of a single-pass mission plan. Note that each slice shown in the figure overlaps with at least one other slice. For example, slice 1 overlaps with slice 2 and slice 3. Each slice k is associated with at least one scanning state Sₖ that describes a coverage opportunity. Thus, each slice includes states or opportunities into which an action (e.g., an image acquisition) can be scheduled. The states associated with slice k will be those whose scanned area lies within that slice k and the null state, in which no action is taken. A person of ordinary skill in the art will understand that the partitioning into slices is not limited to the spatial domain. A similar partitioning can be applied to the temporal domain dividing the timeframe the satellite spends above the coverage area 150 in a similar manner. As in the case of spatial partitioning, each slice will be associated with a set of states describing coverage opportunities in the case of temporal partitioning.

A satellite mission plan (P) consists of a set of chosen scanning states S₁, S₂, S₃, . . . Sₘ. As used herein, Sₖ indicates one of the scanning states S₁ through Sₘ. Scanning is done by a sensor on a satellite that scans a specified. geographic area for the purpose of imaging. Each scanning state is associated with a particular sensor on the satellite that performs the scanning, the period when the scanning takes place, and the spatial positioning of the sensor at the beginning and at the end of the scanning period. In other words, a scanning state Sₖ={sensor, tᵢ, t_{f}, dᵢ, d_{f}, vᵢ, v_{f}, aᵢ, a_{f}} wherein tᵢ and t_{f} denote the initial point in time at which a scanning begins and the final point in time at which the scanning ends, respectively; dᵢ and d_{f} denote the spatial positions of the sensor at times tᵢ and t_{f}, respectively; vᵢ and V_{f} denote the velocities of the sensor at times tᵢ and t_{f}, respectively; and aᵢ and a_{f} denote accelerations of the sensor at times tᵢ and t_{f}, respectively. For purposes of discussion herein, the velocity and acceleration are considered constant in the interest of clarity of illustration. A person of ordinary skill in the art will understand that the applicability of the invention is not limited to a situation involving constant velocity or acceleration, and will know how to adapt the method for situations involving changing velocities and accelerations.

For each scanning state Sₖ, application of the predefined function of merit (F) to that state yields the merit value of the scanning state. This merit function F may take into account various parameters including but not limited to 1) the total area covered by this scanning state, 2) the number of required targets that are covered by this scanning state, 3) the effective scanning resolution (taking into account the scanning elevation angle), 4) the degree to which this scanning state fulfills special specifications for scanning the targets that it covers (e.g., requirements for scanning at a particular time of day or from a particular angle), 5) the predicted visibility in the scanned area (cloud coverage), 6) the target priority, 7) scanning azimuth, 8) positioning precision, 8) radiometric quality level, 9) maneuver rate, and 10) energy consumption rate. Based on the merit of each scanning state, the overall merit of a mission plan P may be calculated as:

$$F ( P ) = {\sum }_{i = 1}^{m} F ( {S}_{i} ) ,$$

wherein i is a counter for scanning states.

Based on this definition of F(P), a mission plan P that provides the highest score F(P) can be estimated to be the best mission plan.

Where requests are grouped into “batches,” the allocation methods described above allocate one batch of request(s) into each state. In this case, the scheduling is done on a batch-by-batch basis.

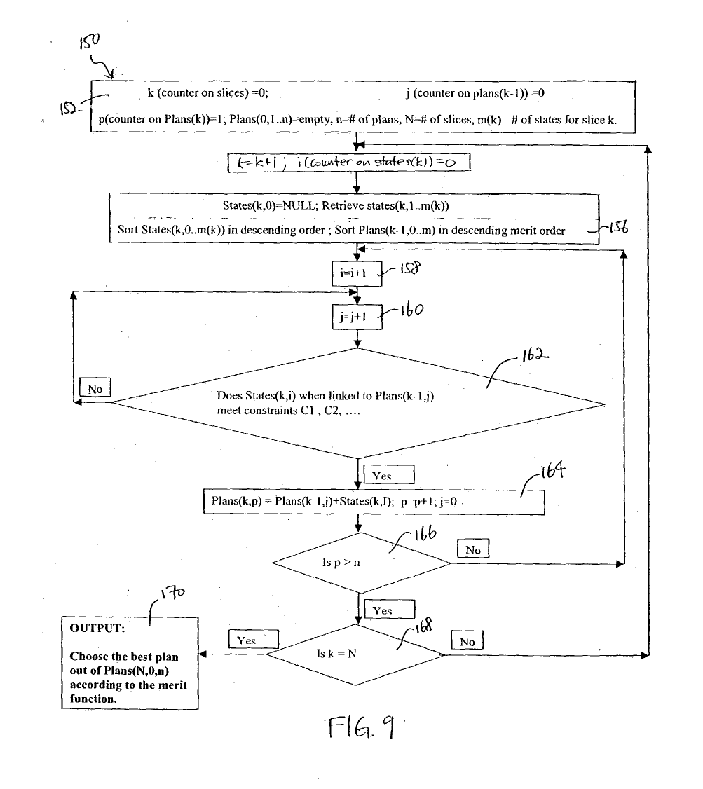

FIG. 9 depicts a flowchart of a dynamic programming scheduling method 150 in accordance with the invention. For clarity of illustration, the dynamic programming scheduling method 150 described herein assumes that the problem is a first order Markov process. In some cases, however, the SSRS problem should be defined as a higher order Markov process and a person of ordinary skill in the art will understand how to adjust the method for the higher order Markov process. The method 150 in accordance with this invention includes using a pruning mechanism in order to choose the best schedules from the first order Markov representation in a way that optimizes the expected schedules for the higher order Markov representation. In this method, this is done by changing the merit function to penalize for conflicts with currently chosen states. As a result, at each phase of the method, the partial schedules that are chosen optimize the expected global merit rather than the deterministic global merit. In this flowchart, the variable “k” is a slice counter that identifies the relevant slice (of time or space) of the total coverage area. The variable “i” is a state counter that identifies one of the possible states in slice k. “States (k)” refers to all the images (or batches) S₁ through Sₘ that may be taken in slice k. For example, if images of Area 1, Area 2, and Area 3 could be taken in slice k, Area 1 could be S₁, Area 1 and Area 2 could both be part of S₂, and Area 3 could be part of S₃. The variable “j” is a plan counter for a set of sequences Plans (k−1). Plans (k−1) includes n sets of sequences wherein each sequence includes images to be taken in a specific order from the first slice to the slice immediately preceding the current slice. The variable “p” is a counter for Plans (k). As Plans (k) includes n sequences of images to be taken from the first slice to the present slice, Plans (k) takes into account one more slice than Plans (k−1).

As an overview of the dynamic programming scheduling method 150, different combinations of the n sequences in Plans (k−1) and the states (k) are tried and each combination is scored based on a sum of the merit values of the individual states in the plan. Out of all the different combinations, n combinations that maximize the expected merit for the complete plans are selected. These n combinations constitute Plans (k) for slice k. As the satellite moves on to the next slice and k is incremented by one, the old Plans (k) becomes the new Plans (k−1) and the whole process is repeated. At the end of each slice, n best Plans (k) are selected, wherein each of the Plans (k) is a schedule of events (e.g., image acquisition requests) from the first slice to the current slice k. Eventually, after the last slice (slice N), n best Plans (N) for the entire pass or passes are determined.

Although the utility of the dynamic programming scheduling method 150 is not limited to satellite scheduling, it provides a particularly efficient solution to satellite scheduling because the position, velocity, and acceleration of a satellite sensor have a short term effect on the satellite's position at later stages. This characteristic makes it unnecessary to optimize an entire satellite pass at once. Therefore, a satellite pass can be scheduled dynamically on a slice-by-slice basis.

The dynamic programming scheduling method 150 will now be explained in reference to the flowchart. Initially, before information for the first slice is processed, counters k, and j are set to zero (stage 152). The counter p for Plans (k) is set to “1” since the process that is to be performed is for the first slice. At this point, there is no Plans (k−1) since no data has been taken yet. Thus, Plans (k−1) is empty. As used in this flowchart, m(k) indicates the total number of states in slice k.

As the scheduling method/mission planning system begins to perform the dynamic programming method 150 for the first slice, the slice counter k is incremented by 1 from k=0 to k=1 initially, and the counter i is set to zero (stage 154). In stage 156, the states (k) includes a state (k,0) (also expressed as “S₀”), which is a null state indicating that no image is taken, and states (k,1), states (k,2) . . . states (k, m(k)), each of which indicates one sensor scan between two specific points in time within slice k. The merit for each scanning state is determined based on the factors mentioned above. When there are different combinations and/or sequences of states, each combination or sequence is associated with a merit value. The different sequences (also called plans) are sorted according to their merit value (also stage 156).

In stage 158, the state count “i” is incremented by one. In stage 160, the Plans (k−1) counter (j) is incremented by one. So, if this is the first time going through this process, i and j are both incremented from 0 to 1. In stage 162, it is checked whether a new plan that is a combination of Plan j and state i is a viable plan. Thus, when both i and j are 1, the method determines whether a combination of Plans (k−1, 1) and state 1 makes a viable Plans (k,1). In order for a mission plan that includes scanning states S0, S₁, S₂, S₃, . . . Sₘ to be a viable plan, the plan has to satisfy the following constraints:

1) t_{f} (Sₖ)<tᵢ(Sₖ₊₁), and

2) the transition from d_{f}(Sₖ) to dᵢ(Sₖ₊₁) can be made within time period Δt, wherein Δt=tᵢ(Sₖ₊₁)−t_{f}(Sₖ).

The first constraint requires that a preceding scan must be complete before a new scan begins. This is a reasonable constraint given that the constraint applies to a single sensor that can only be in one scanning state at a time. The second constraint requires that the sensor is able to transition from the final position of one scan to the beginning position of the next scan before the next scan begins. The second constraint ensures that the sensor can move to the proper scan position before the scanning begins. If these two constraints are not satisfied (stage 162), the plan is determined to be non-viable and the process loops back to stage 160 where j (the plan counter) is incremented again to compare another plan with its states to the constraints. The non-viable plan is discarded.

If j is incremented to j=2, the process is repeated with the combination of state 1 and Plan 2. If the constraints are satisfied in stage 162, on the other hand, the combination is added to Plans (k) in stage 164. Since the number of plans in Plans (k) increased by one, the plan counter p for Plans (k) is incremented by one. At this point, the counter j is reset to zero because i will be reset if stage 158 is repeated, and each state i should be combined with an entire set of Plans (k−1) in order to ensure that the best plan is not missed.

In stage 166, it is checked whether p is greater than n. As previously mentioned, Plans (k−1) and Plans (k) each contain n plans. If the incremented p is not greater than n, indicating that more plans are needed for Plans (k), the process loops back to stage 158, increments i again, and repeats stages 160, 162, and 164 with a new state, State (k,i). On the other hand, if the incremented p is greater than n, indicating that no more plans are needed for Plans (k), the method determines whether the slice k is the last slice of the pass, i.e. k=N (stage 168). If k=N, an output is calculated by selecting the best plan out of the n plans in Plans (N) according to the merit value F(P) (stage 170). If k is less than N, on the other hand, it indicates that there are slices left to be processed. Thus, the process starting at stage 154 repeats. the other hand, it indicates that there are slices left to be processed. Thus, the process starting at stage 154 repeats.

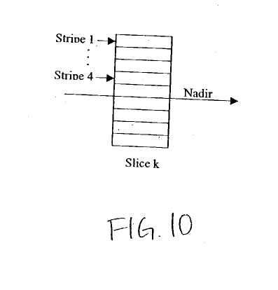

FIG. 10 depicts a subdivision method 180 that may optionally be implemented in conjunction with the dynamic programming scheduling method 150 to avoid selecting a locally optimal solution as the best plan. The subdivision method 180 includes dividing each slice k into several “subparts” along a line that is perpendicular to the line along which the slices lie. In other words, each slice k is divided into subparts arranged in a direction perpendicular to the direction in which the satellite advances, as illustrated in FIG. 10. For example, if the satellite is advancing from north to south within a relevant slice, the subparts divide the slice in the east-west direction. The subdivision method 180 requires that a plan include a state covering at least one target in each subpart that contains a target. Alternatively, the subdivision method 180 may determine the number of high- priority targets in each subpart and require that the number of plans including each subpart of slice k be proportional to the number of high-priority targets in that subpart. The subdivision method 180 forces the dynamic programming scheduling method 150 to consider states in different parts of a slice rather than a few concentrated areas of a slice, thereby ensuring that what is finally selected as the best plan is not just a locally optimal plan.

FIG. 11A and FIG. 11B depict one plan 200 in Plans (k) as may be displayed on the user interface 59 (see FIG. 4). A circular area 202 encompassing a plurality of lines depicts a ground station coverage area. One or more solid lines 204 depict the predetermined satellite pass routes. Each satellite traveling along one of the solid lines 204 can take images of the area delineated by two dashed lines 206 that stretch alongside the solid lines 204. FIG. 11A depicts the satellite pass plans over the coverage area 202 without any plans. FIG. 11B depicts a plan superimposed on one of the solid lines 204. The lines that protrude from the solid line 204 in FIG. 11B indicate scanning of an area. Some of the lines form a triangle with one side being formed by a part of the solid line 204. In this case, the image was taken for the duration of time it took the satellite to travel from one end of the overlapping side of the triangle to the other end. The vertex of the triangle that is opposite the side that overlaps the solid line 204 is where the scanned area is located. The multitude of short lines that cross the solid line 204 represent images taken of targets that are located closer to the satellite pass route than the targets located at the vertex of the triangles.

The dynamic programming scheduling method 150 overcomes the challenging complexity of SRSS by performing computations based on just a few steps of a longer history. More specifically, out of the N slices, only a simple representation of the history up to slice k−1 and slice k are used to generate the next step, which is then turned into k−1. Thus, the dynamic programming method 150 is applicable to any Markovian decision process. In this context, only a few steps (a previous step and a current step) along with calculations based on a few more steps are used to generate the optimal solution out of a long history of steps. In a context like satellite scheduling where the number of possible scan combinations over a satellite pass is so enormous as to be problematic, this dynamic programming method in accordance with the invention presents a ground-breaking step toward automation of satellite scheduling.

While the foregoing has been with reference to a particular embodiment of the invention, it will be appreciated by those skilled in the art that changes in this embodiment may be made without departing from the principles and spirit of the invention, the scope of which is defined by the appended claims.

What is claimed is:

1. A method of scheduling image acquisition tasks for an image acquisition device that travels along a path, the method comprising:
dividing an image acquisition device path so that there is at least a first portion and a second portion at any given moment, wherein each of the first portion and the second portion includes at least one state;
combining each state in the first portion with at least one state in the second portion one by one to generate a series of updated sequences; and
selecting at least one of the updated sequences based on a merit value associated with each of the updated sequences.

2. The method of claim 1, wherein the at least one state includes a null state in which no image is taken.

3. The method of claim 1 further comprising:
determining a scanning period for each state;
checking whether the updated sequences include overlapping scanning periods for consecutive sensor positions; and
discarding at least one of the updated sequences if necessary to eliminate the overlapping scanning periods.

4. The method of claim 1 further comprising checking each of the updated sequences to make sure consecutive states in the updated sequences are physically feasible under specific time constraints.

5. The method of claim 1 further comprising:
dividing the first portion into subparts; and
including, in the updated sequences, a state for a target in each of the subparts that has a target.

6. The method of claim 1 further comprising:
dividing the first portion into subparts;
assigning a priority level to each of the subparts based on number and importance of the targets in the subparts; and
requiring that the number of updated sequences that include a state in a particular subpart correlates with the priority level of the particular subpart.

7. The method of claim 1, wherein the merit value is determined based on at least one of: a total area covered by each state, a number of required targets that are covered by each state, an effective scanning resolution, a degree to which each state fulfills special specifications for scanning relevant targets, a predicted visibility in the scanned area, a target priority, scanning azimuth, positioning precision, radiometric quality level, maneuver rate, and energy consumption rate.

8. The method of claim 1 further comprising receiving imaging requests with specifications including at least one of target location, minimum resolution, time of day, azimuth, priority, wavelength, scanning mode, and urgency level.

9. The method of claim 8 further comprising grouping the imaging requests into a batch based on the specifications of the imaging requests, wherein the imaging requests in the batch is fulfilled in a continuous scanning period of the image acquisition device.

10. The method of claim 8 further comprising checking a database for a stored image that matches the specifications.

11. The method of claim 1, wherein the image acquisition device path includes multiple passes and the scheduling is done for the multiple image acquisition device passes simultaneously.

12. The method of claim 1, wherein the image acquisition device path includes multiple image acquisition device passes and the scheduling is done for one pass at a time.

13. The method of claim 1, wherein the image acquisition device comprises a satellite.

14. The method of claim 13 further comprising retrieving predetermined information for identifying possible sensor positions, wherein the predetermined information includes information about at least one of satellite geometry model, energy model, sensor model, orbit predictions, SSR constraints, and radiometric model.

15. The method of claim 1 further comprising retrieving time-dependent information for identifying possible sensor positions, wherein the time-dependent information includes at least one of weather information, date and time, radiometric information, sun position, and SSR status information.

16. The method of claim 1 further comprising displaying the updated sequences that are selected on a graphic display of a user interface.

17. The method of claim 1 further comprising allocating image acquisition tasks to image acquisition device passes before scheduling the allocated image acquisitions within each image acquisition device pass.

18. The method of claim 17 wherein allocating image acquisition tasks comprises:
assigning a merit value to each imaging request; and
allocating the imaging request having a highest merit value to an available image acquisition device pass that optimizes the imaging request.

19. The method of claim 18 further comprising checking whether there is an available image acquisition device pass capable of accommodating the imaging request.

20. The method of claim 17 wherein the allocating comprises:
choosing a first allocation;
calculating a first merit value for the first allocation;
choosing a second allocation;
calculating a second merit value for the second allocation;
comparing the first and the second merit values; and
selecting one of the first allocation and the second allocation based on the comparison.

21. The method of claim 1 further comprising:
receiving image acquisition requests;
allocating a subgroup of the image acquisition requests to multiple image acquisition device passes; assigning each of the image acquisition requests in the subgroup to an optimal pass;
calculating an overall merit value of the allocation; and
reassigning some of the allocated image acquisition requests to a different pass to increase the overall merit value.

22. The method of claim 21 wherein calculating the overall merit value further comprises:
calculating a sum of merits of each allocated image acquisition request;
calculating a sum of penalties for each allocated image acquisition request; and
combining the sum of merits and the sum of penalties.

23. The method of claim 1 wherein a target is imaged more than once.

24. The method of claim 1 further comprising:
translating the selected updated sequence(s) into image acquisition device commands; and
sending the image acquisition device commands to an appropriate image acquisition device.

25. A method of efficiently assigning actions, to a sequence of opportunities, the method comprising:
allocating a subgroup of requested actions to predetermined sets of opportunities by assigning each action in the subgroup to one of the sets;
iteratively adjusting the allocation in each of the image acquisition device passes to improve the merit value associated with the overall allocation, wherein this iterative adjustment includes using a predetermined merit that is associated with a specific allocation and a penalty that is associated with a potential conflict; and
after the allocation is complete, determining the order of the allocated actions within each of the sets by using a method based on dynamic programming.

26. The method of claim 25, wherein iteratively adjusting the allocation comprises:
calculating a merit for each action in the allocated subgroup;
calculating a sum of merits for allocated actions in one of the sets;
calculating a penalty associated with each action in the allocated subgroup;
calculating a sum of penalties for the allocated actions in the set for which the sum of merits is calculated; and
combining the sum of merits and the sum of penalties to determine an overall merit for the set.

27. The method of claim 26 further comprising:
reassigning at least one of the allocated actions to a different set; and
recalculating a combination of the sum of merits and the sum of penalties.

28. The method of claim 27 further comprising:
checking if a stop condition is satisfied after each recalculation, wherein the stop condition is at least one of a predetermined length of time and a lower than minimum improvement in the overall merit over a predetermined number of iterations; and
operating on another set if the stop condition is satisfied so that eventually, the overall merit is maximized for each of the sets.

29. The method of claim 25, wherein determining the order of the allocated actions comprises:
dividing a set of opportunities in each set into a first portion and a second portion;
combining each opportunity of the first portion with a sequence of at least one opportunity in the second portion to generate updated sequences of opportunities; and
selecting at least one of the updated sequences of opportunities based on a predetermined criterion.

30. The method of claim 29, wherein the opportunities include a null state into which no action is scheduled.

31. The method of claim 29 further comprising:
determining a period for each of the actions;
checking whether the selected updated sequences include overlapping periods for consecutively scheduled events; and
discarding at least one of the updated sequences if necessary to eliminate the overlapping scanning periods.

32. The method of claim 29 further comprising checking each of the updated sequences to ensure that consecutively scheduled events are physically feasible given specific time constraints.

33. The method of claim 29 further comprising:
dividing the first portion into subparts; and
scheduling an action into every one of the subparts that includes an opportunity capable of accommodating the action.

34. The method of claim 29 further comprising:
dividing the current portion into subparts;
assigning a priority level to each of the subparts based on type, number and importance of the actions the subparts are capable of accommodating; and
requiring the number of updated sequences including each of the subparts to be proportional to the priority level of the respective subparts.

35. The method of claim 29, wherein the predetermined criterion correlates to at least one of: a total area covered by each state, a number of required targets that are covered by each state, an effective scanning resolution, a degree to which each state fulfills special specifications for scanning relevant targets, a predicted visibility in the scanned area, a target priority, scanning azimuth, positioning precision, radiometric quality level, maneuver rate, and energy consumption rate.

36. The method of claim 29 further comprising:
displaying the selected updated sequences on a graphic display of a user interface; and
receiving input from the user interface.

37. A system for scheduling image acquisitions for an image acquisition device that travels along a path, the system comprising:
computer instructions for dividing the path so that there is a first portion and a second portion, wherein each of the first portion and the second portion includes at least one state;
computer instructions for combining each state in the first portion with at least one state in the second portion one by one to generate a series of updated sequences; and
computer instructions for selecting at least one of the updated sequences based on a merit value associated with each of the updated sequences.

38. The system of claim 37, wherein at least one of the first portion and the second portion includes a null state in-which no image is taken.

39. The system of claim 37 further comprising:
computer instructions for determining a scanning period for each of the possible sensor positions;
computer instructions for checking whether the updated sequences include overlapping scanning periods for consecutive sensor positions; and
discarding at least one of the updated sequences if necessary to eliminate the overlapping scanning periods.

40. The system of claim 37 further comprising computer instructions for checking each of the updated sequences to make sure consecutive sensor positions are physically feasible under specific time constraints.

41. The system of claim 37 further comprising:
computer instructions for dividing the first portion into regions; and
computer instructions for including, in the updated sequences, a sensor position for a target in each of the regions that includes a target.

42. The system of claim 37 further comprising:
computer instructions for dividing the first portion into subparts;
computer instructions for assigning a priority level to each of the subparts based on number and importance of the targets in the subparts; and
computer instructions requiring that the number of updated sequences including a state in a particular subpart correlates with the priority level of the particular subpart.

43. The system of claim 37, wherein the merit value correlates to at least one of: a total area covered by each state, a number of required targets that are covered by each state, an effective scanning resolution, a degree to which each state fulfills special specifications for scanning relevant targets, a predicted visibility in the scanned area, a target priority, scanning azimuth, positioning precision, radiometric quality level, maneuver rate, and energy consumption rate.

44. The system of claim 37 further comprising computer instructions for receiving imaging requests having specifications including at least one of target location, minimum resolution, time of day, azimuth, priority, wavelength, scanning mode, and urgency level.

45. The system of claim 44 further comprising grouping the imaging requests into batches based on the specifications, wherein one of the batches is fulfilled with one scan.

46. The system of claim 44 further comprising a database for a storing acquired images.

47. The system of claim 37, wherein the path includes multiple image acquisition device passes.

48. The system of claim 37 further comprising computer instructions for retrieving predetermined information for identifying possible sensor positions, wherein the predetermined information includes information about at least one of image acquisition device geometry model, energy model, sensor model, two-line elements, disk constraints, and radiometric model.

49. The system of claim 37 further comprising computer instructions for retrieving time-dependent information for identifying possible sensor positions, wherein the time-dependent information includes at least one of weather information, time of day, radiometric information, sun position, and disk information.

50. The system of claim 37 further comprising:
computer instructions for displaying the updated sequences that are selected on a graphic display of a user interface; and
computer instructions for receiving input from the user interface.

51. The system of claim 37 further comprising an allocation module for allocating image acquisitions to image acquisition device passes before scheduling.

52. The system of claim 51 wherein the allocation module comprises:
computer instructions for assigning a merit value to each imaging request; and
computer instructions for allocating the imaging request having a highest merit value to an available image acquisition device pass that optimizes the imaging request.

53. The system of claim 52 further comprising computer instructions for checking whether there is an available image acquisition device pass capable of accommodating the imaging request.

54. The system of claim 51 wherein the allocation module comprises:
computer instructions for choosing an initial allocation;
computer instructions for calculating the merit value for the initial allocation;
computer instructions for choosing a second allocation;
computer instructions for calculating the merit value for the second allocation;
computer instructions for comparing the merit values of the initial allocation and the second allocation; and
computer instructions for selecting one of the initial allocation and the second allocation based on the comparing.

55. The system of claim 37 further comprising:
computer instructions for receiving image acquisition requests;
computer instructions for allocating a subgroup of the image acquisition requests to multiple image acquisition device passes;
computer instructions for assigning each of the image acquisition requests in the subgroup to an optimal pass;
computer instructions for calculating an overall merit value of the allocation; and
computer instructions for adjusting some of the assignments to a different pass is necessary to increase the overall merit value.

56. The system of claim 55, wherein the computer instructions for calculating the overall merit value further comprises:
computer instructions for calculating a sum of merits of each allocated image acquisition request;
computer instructions for calculating a sum of penalties for each allocated image acquisition request; and
computer instructions for combining the sum of merits and the sum of penalties.

57. The system of claim 37 wherein a target is imaged more than once.

58. The system of claim 37 further comprising:
a control system for translating the at least one updated sequences into image acquisition device commands; and
an image acquisition device transceiver for sending the image acquisition device commands to an appropriate image acquisition device.

59. A system for determining a sequence of opportunities that would yield a desired result when actions are scheduled into the opportunities, the system comprising:
computer instructions for allocating a subgroup of requested actions among sets of opportunities by assigning each action in the subgroup to one of the sets of opportunities that optimizes a merit value;
computer instructions for iteratively adjusting the allocation in each of the sets to improve the merit value of the overall allocation, wherein this iterative adjustment includes using a predetermined merit that is associated with a specific allocation and a penalty that is associated with a potential conflict; and
computer instructions for determining the order of the allocated actions in each of the image acquisition device passes using a method based on dynamic programming.

60. The system of claim 59, wherein the computer instructions for iteratively adjusting the allocation comprises:
computer instructions for calculating a merit for each action in the allocated subgroup;
computer instructions for calculating a sum of merits for allocated actions in a set of opportunities;
computer instructions for calculating a penalty associated with each action in the. set of opportunities;
computer instructions for calculating a sum of penalties for the allocated actions in the set of opportunities; and
computer instructions for calculating a difference between the sum of merits and the sum of penalties to determine an overall merit for the set of opportunities.

61. The system of claim 60 further comprising:
computer instructions for reassigning at least one of the allocated actions to a different set; and
computer instructions for recalculating the difference between the sum of merits and the sum of penalties.

62. The method of claim 61 further comprising:
computer instructions for checking if a stop condition is satisfied after each recalculation, wherein the stop condition is at least one of a predetermined length of time and a lower than minimum improvement in the overall merit over a predetermined number of iterations; and
computer instructions for operating on to another image acquisition device pass if the stop condition is satisfied so that ultimately, the overall merit is maximized for each of the sets of opportunities.

63. The system of claim 59, wherein computer instructions for determining the order of the allocated actions comprises:
computer instructions for dividing a set of opportunities in each image acquisition device pass into a first portion and a second portion;
computer instructions for combining each opportunity of the first portion with a sequence of at least one opportunity in the second portion to generate updated sequences of opportunities; and
computer instructions for selecting at least one of the updated sequences of opportunities based on a predetermined criterion.

64. A method of allocating requested actions to a plurality of sets of opportunities, the method comprising:
selecting a subgroup of the requested actions;
determining, for each requested action in the subgroup, an optimal allocation that maximizes an individual merit value for the requested action;
Calculating the merit of the allocation by generating a sum of individual merits and penalizing for potential conflict among different requested actions;
Reallocating different requested actions in order to optimize the overall merit of the allocation; and
designating as a final allocation an allocation that maximizes an overall merit value for the plurality of sets.
